(19) United States
(12) Patent Application Publication
(10) Pub. No.: US 2022/0024752 A1
(43) Pub. Date: Jan. 27, 2022

(54) SADDLE CHAIR WITH A DIVIDED SEAT

(71) Applicant: Easydoing Oy, 77700 Rautalampi (FI)

(72) Inventor: Veli-Jussi Jalkanen, Rautalampi (FI)

(73) Assignee: Easydoing Oy, 77700 Rautalampi (FI)

(21) Appl. No.: 17/289,885

(22) PCT Filed: Oct. 30, 2019
(86) PCT No.: PCT/FI2019/050774

§ 371 Date: Apr. 29, 2021

(51) Int. Cl. B68C 1/04

(52) U.S. Cl. CPC B68C 1/04

(57) ABSTRACT

A saddle chair with a divided seat for reducing pressure on the perineum and lowering temperature in the genital area, the divided seat of which comprises a first seat part and a second seat part. It is proposed a saddle chair (10) in which the first seat part (30) and the second seat part (40) are arranged pivotably such that they are rotatable around a pivot (J1) positioned near the back edge (12) of the divided seat (20), leaving an adjustable gap (G1) at the front edge (11) of the divided seat (20). The saddle chair (10) further comprises a locking device (200) for locking and unlocking the pivotal position of the first seat part (30) and of the second seat part (40).

### FIELD OF THE INVENTION

The invention relates saddle chairs with a divided seat.

### BACKGROUND OF THE INVENTION

A saddle chair may use the same principles in its design as an equestrian saddle. A saddle chair may comprise a seat in the form of a saddle, a support cylinder and a chair base. The support cylinder may be a gas cylinder providing height adjustment of the seat. The chair base may be provided with casters. Saddle chairs do not normally have a back rest. The casters enable moving around and reaching out for objects while sitting on the saddle chair.

A riding-like sitting on a saddle chair differs from sitting on a conventional chair. Saddle chair users usually sit about 20-30 cm higher, which puts the hips and the knees into an angle of about 135 degrees. This angle is typically 90 degrees when sitting on a traditional chair.

The seat of a saddle chair may be solid or divided. A divided seat reduces pressure on the perineum and lowers the temperature in the genital area. A divided seat is thought to be healthier, especially for men, compared to a solid seat.

Saddle chairs may include adjustment of the height of the saddle chair and also a mechanism providing swing of the saddle. The height adjustment may be provided by a gas cylinder extending between the seat and the chair base. Saddle chairs with divided seats may also have an adjustable gap between the two seat parts. Accessories, such as elbow and wrist supports, are available for saddle chairs to make different work tasks easier.

### SUMMARY OF THE INVENTNION

One object of the invention is a saddle chair with a divided seat for reducing pressure on the perineum and lowering temperature in the genital area. The divided seat comprises a first seat part and a second seat part, wherein the first seat part and the second seat part are arranged pivotably such that they are rotatable around a pivot positioned near a back edge of the divided seat, leaving an adjustable gap at a front edge of the divided seat. The saddle chair further comprises a locking device, for locking and unlocking a pivotal position of the first seat part and of the second seat part.

According to one embodiment, the saddle chair may further comprise a bridge support device, wherein the first seat part is supported on a first support plate of the bridge support device and the second seat part is supported on a second support plate of the bridge support device. The first seat part and the second seat part are positioned on a stationary bottom plate of the bridge support device, wherein the pivot is on the bottom plate. The first support plate and the second support plate are movably supported via the first pivot on the stationary bottom plate so that the first support plate and the second support plate are movable in relation to each other and in relation to the bottom plate around the first pivot.

In another embodiment the saddle chair may further comprise a grip, such as a handwheel, connected via a shaft to a rotatable member, such as a rotatable plate, arranged by its rotating movement to move a first arm to pivot the first seat part in a first direction and a second arm to simultaneously pivot the second seat part in to a second direction that is opposite to the first direction.

In yet another embodiment the saddle chair may further comprise a grip, such as a handwheel, connected via a shaft to a rotatable member, such as a rotatable plate, arranged by its rotating movement to operate power transmissions such as cog wheels to pivot the first seat part in a first direction and the second seat part in a second direction that is opposite to the first direction. The pivoting of the first seat part and of the second seat part is guided by form-locking means.

In yet another embodiment, the pivoting of the first seat part and of the second seat part is carried out symmetrically such that an adjustable gap is widened or narrowed by respective pivoting of the first seat part and of the second seat part.

The saddle chair may further comprise a support cylinder arranged such that the pivoting of the first seat part and of the second seat part is carried out symmetrically with respect to the support cylinder. In this embodiment, a longitudinal centre line of the saddle chair passes along the gap between the first seat part and the second seat part.

The first seat part and the second seat part may be symmetrical in view of a vertical symmetry plane that passes along a centre axis of the support cylinder and also in view of the centre axis of the support cylinder.

In another embodiment, the saddle chair locking device may comprise an eccentric surface that is rotatable by a handle, and wherein the eccentric surface may be configured in the locked position to press a lock profile against a support plate, the friction caused by pressure serves to lock the support plates in relation to a bottom plate to prevent pivoting of the first seat part and of the second seat part.

The eccentric surface may have a number of grooves and wherein the locking device may further comprise a number of spring loaded balls of plungers such that the spring loaded balls are pressed into a first groove when the handle is in the locked position and into a second groove when the handle is in the unlocked position.

In a further embodiment, the saddle chair may further comprise a swing support device between a support cylinder and a bridge support supporting the first seat part and the second seat part, for providing swing of the saddle chair.

In addition, the first seat saddle part and the second seat saddle part may jointly have a seat surface having a design of an equestrian saddle but with an adjustable gap at the front edge between the first seat part and the second seat part, for reducing pressure on the perineum and lowering temperature in the genital area.

An additional object of the present invention is generally to improve the adjustability of a saddle chair with a divided seat.

This object can be met with a saddle chair according to the independent claim.

The dependent claims describe advantageous aspects of the saddle chair.

According to one aspect the bridge support device for the divided seat saddle chair comprises

a bottom plate,

a first support plate positioned on the bottom plate,

a second support plate positioned on the first support plate,

a first pivot provided on the bottom plate, whereby

the first support plate and the second support plate are movably supported via the first pivot on the stationary bottom plate so that the first support plate and the second support plate are movable in relation to each other and in relation to the bottom plate around the first pivot.

The bridge support device provides a simple, reliable and cost effective support for a saddle chair with a divided seat making it possible to easily adjust the gap between the two seat parts in the seat in the saddle chair.

The bridge support device provides a precise and fully controlled adjustment of the first and the second support plate and thereby of the two seat parts in the saddle chair. The saddle chair remains symmetrical throughout the adjustment of the two support plates around the first pivot. The two seat parts of the saddle chair move equally in relation to a vertical plane of symmetry passing through the middle points between the two seat parts of the saddle chair.

An adjustment device for moving the first support plate and the second support plate around a first pivot may be included in the bridge support in an embodiment of the invention. The adjustment device may be supported on the bottom plate. The adjustment device may have means for moving the first support plate and means for moving the second support plate around the first pivot. The adjustment device may be mechanical.

A locking device for locking the first support plate and the second support plate in relation to the bottom plate may further be included in the bridge support device in an embodiment of the invention. The locking device may be supported on the bottom plate. The locking device may be mechanical.

### DRAWINGS

In the following the invention will be described in greater detail by means of preferred embodiments with reference to the attached drawings, in which

FIG. 1 shows a bottom view of a saddle chair with a divided seat,

FIG. 2 shows a first view of a bridge support device of a saddle chair with a divided seat,

FIG. 3 shows a second view of the bridge support device of FIG. 2,

FIG. 4 shows a top view of a locking device in the bridge support device of the saddle chair,

FIG. 5 shows a bottom view of the locking device of FIG. 4,

FIG. 6 shows a front view of the locking device of the saddle chair,

FIG. 7 shows a cross section A-A of FIG. 6,

FIG. 8 shows a cross section B-B of FIG. 6,

FIG. 9 shows a side view of the handle of the locking device in an open position,

FIG. 10 shows a side view of the handle of the locking device in an open position,

FIG. 11 shows a dust cover to be used in the saddle chair,

FIG. 12 shows a cross section of the support element of the dust cover,

FIG. 13 shows a side view of a swing bridge support device of a saddle chair.

### DETAILED DESCRIPTION OF THE INVENTION

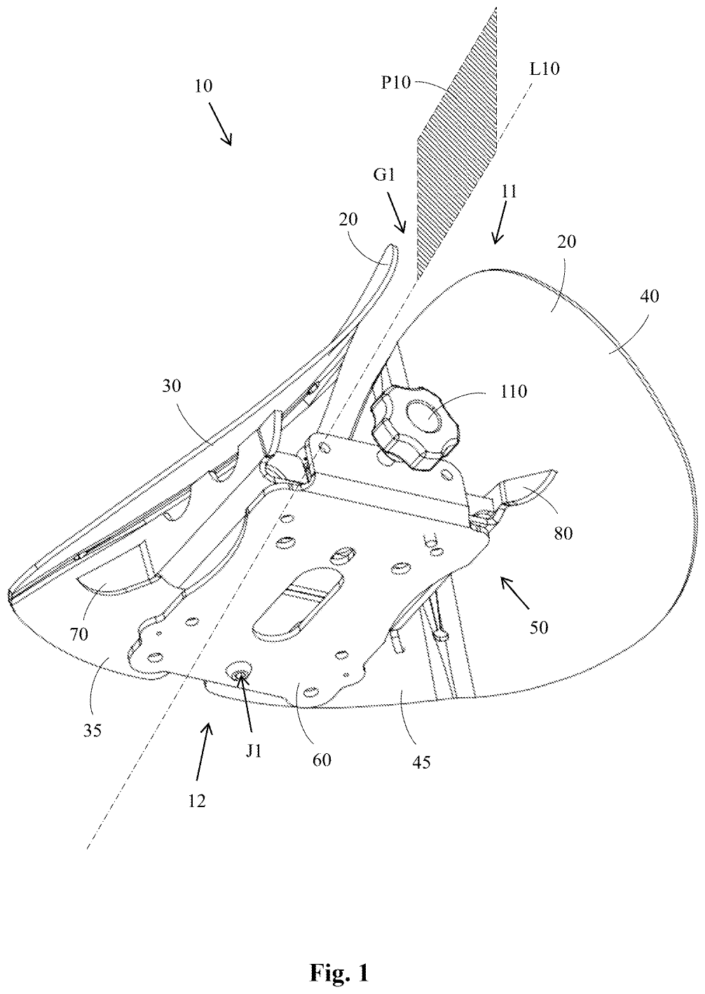

FIG. 1 shows a bottom view of a saddle chair with a divided seat.

The saddle chair 10 comprises a divided seat 20 having a first seat part 30 and a second seat part 40 and a bridge support device 50.

The first seat part 30 comprises a first seat plate 35 and the second seat part 40 comprises a second seat plate 45. The first seat part 30 and the second seat part 40 is separated by a gap G1. A longitudinal centre line L10 of the saddle chair 10 passes along the gap G1 between the first part 30 and the second part 40 of the seat 20 of the saddle chair 10. The longitudinal centre line L10 passes between a centre of a front edge 11 of the seat 20 of the saddle chair 10 and a centre of a back edge 12 of the seat 20 of the saddle chair 10. A vertical plane of symmetry P10 passes through the longitudinal centre line L10. The first seat part 30 and the second seat part 40 are positioned on opposite sides of the vertical plane of symmetry P10. The first seat part 30 and the second seat part 40 may form mirror images of each other in view of the vertical plane of symmetry P10. The first seat part 30 and the second seat part 40 may be symmetric in relation to each other in view of the vertical plane of symmetry P10. The front edge 11 of the seat 20 of the saddle chair 10 is positioned in the right upper corner in the figure and the back edge 12 of the saddle chair 10 is positioned in the left lower corner in the figure. A person sitting on the saddle chair 10 is thus sitting so that the front of the person is facing the front edge 11 of the seat 20 of the saddle chair 10 and the back of the person is facing the back edge of the seat 20 of the saddle chair 10.

The bridge support device 50 comprises a bottom plate 60, a first support plate 70, and a second support plate 80. The first support plate 70 is positioned on the bottom plate 60. The second support plate 80 is positioned on the first support plate 70. The first seat plate 35 in the first seat part 30 is supported on the first support plate 70. The second seat plate 45 in the second seat part 40 is supported on the second support plate 80.

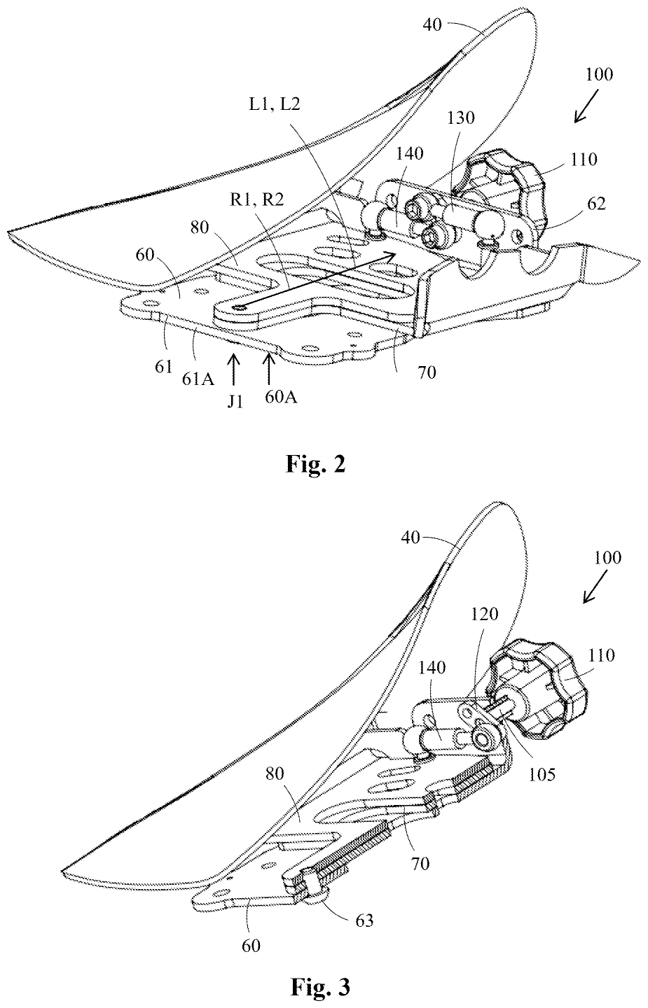

FIG. 2 shows a first view of a bridge support device of a saddle chair and FIG. 3 shows a second view of the bridge support device of FIG. 2.

The bottom plate 60 may extend in a bottom plane. The first support plate 70 may extend in a first plane. The second support plate 80 may extend in a second plane. The bottom plane, the first plane and the second plane may be parallel. The first support plate 70 and the second support plate 80 may be movably supported on the bottom plate 60. The first support plate 70 and the second support plate 80 may be movable in relation to each other and in relation to the stationary bottom plate. A first pivot J1 may be provided on the bottom plate 60. The first support plate 70 and the second support plate 80 may be movably supported on the bottom plate 60 via the first pivot J1.

The bottom plate 60 may comprise a first plate portion 61 and a second end portion 62. The first plate portion 61 may extend in the bottom plane. The first portion 61 may comprise a first edge 61A and a second opposite edge 61B. The second portion 62 may extend along the second edge 61B of the first portion 61. The second end portion 62 may be inclined in relation to the first plate portion 61. The second end portion 62 may thus be inclined in relation to the bottom plane. The second end portion 62 may extend upwards from the first plate portion 61. The angle between the first portion 61 and the second end portion 62 may be 90 degrees. The bottom plate 60 may be formed of a single plate whereby the second end portion 62 may be formed by bending the plate so that an end portion i.e. the second end portion 62 of the plate becomes inclined in relation to the bottom plane. The first plate portion 61 and the second end portion 62 may on the other hand be made of two separate parts. The second end portion 62 may be attached with welding or with a pressure joint e.g. with screws or bolts and nuts to the first plate portion 61. The second end portion 62 may be facing towards the front edge 11 of the seat 20 of the saddle chair 10. The first edge 61A of the first plate portion 61 may be facing towards the back edge 12 of the seat 20 of the saddle chair 10.

The first pivot J1 on the bottom plate 60 may be realized with a screw 63 passing from the underside of the bottom plate 60 through a threaded hole in the bottom plate 60 and further through a plain hole in the first support plate 70 and still further through a plain hole in the second support plate 80. The first support plate 70 and the second support plate 80 may be supported on the first pivot J1 so that they are movable in relation to each other and in relation to the bottom plate 60. The threaded hole in the bottom plate 60 for the screw 63 may be positioned in the first plate portion 61 of the bottom plate 60. Said threaded hole may be positioned adjacent to a first edge 61A of the first plate portion 61 of the bottom plate 60. The first edge 61A and the second edge 61B of the first plate portion 61 of the bottom plate 60 may also form the first edge and the second edge of the bottom plate 60. The distance from the first edge 61A of the bottom plate 60 to the first pivot J1 may be 5 to 20%, advantageously 5 to 10% of the total length of the bottom plate 60 in the longitudinal direction L10 of the saddle chair 10. The first edge 61A of the bottom plate 60 may be near the rear edge 12 of the seat 20 of the saddle chair 10. The second edge 61B of the bottom plate 60 may be at a distance from the front edge 11 of the seat 20 of the saddle chair 10.

A first radius R1 may extend from the first pivot J1 along a first longitudinal centre line L1 of the first support plate 70. A second radius R2 may extend from the first pivot J1 along a second longitudinal centre line L2 of the second support plate 80. A first angle α1 may be formed between the first radius R1 and the second radius R2. The longitudinal centre lines L1, L2 of the first support plate 70 and the second support plate 80 are superimposed in the figure. This means that the first support plate 70 and the second support plate 80 are both in a neutral position i.e. the first angle α1 between the first radius R1 and the second radius R2 is zero degrees in the figure.

The first support plate 70 and the second support plate 80 are thus movably supported via the first pivot J1 on the bottom plate 60. The first support plate 70 and the second support plate 80 may be rotated around the first pivot J1. The first pivot J1 may be positioned adjacent to the first edge 61A of the bottom plate 60. The first support plate 70 and the second support plate 80 are movable in relation to each other and in relation to the bottom plate 60 around the first pivot J1. The first support plate 70 may move in the first plane and the second support plate 80 may move in the second plane. Rotation of the first support plate 70 and the second support plate 80 in relation to each other makes it possible to adjust the gap G1 between the two seats 30, 40 in the divided seat 20 in the saddle chair 10. The gap G1 between the two seat parts 30, 40 in the seat 20 in the saddle chair 10 will thus be adjusted along a circumference of a circle having the centre in the first pivot J1. The adjustment of the gap G1 between the two seat parts 30, 40 of the seat 20 of the saddle chair 10 operates so that an increase in the width of the gap G1 between the two seat parts 30, 40 at the front edge 11 of the seat 20 results in a decrease of the width of the gap G1 between the two seat parts 30, 40 of the seat 20 of the saddle chair 10 at the back edge 12 of the seat 20 and vice a versa. The fact that the first pivot J1 is positioned near the back edge 12 of the seat 20 of the saddle chair 10 results in a much greater decrease and/or increase of the gap G1 between the seat parts 30, 40 at the front edge 11 of the seat 20 compared to the decrease and/or increase of the gap G1 between the seat parts 30, 40 at the back edge 12 of the seat 20.

The bridge support device 50 may further comprise an adjustment device 100 for adjusting the first angle α1. Adjustment of the first angle α1 means adjustment of the gap G1 between the seat parts 30, 40 of the seat 20 of the saddle chair 10. The first seat part 30 of the saddle chair 10 is attached to the first support plate 70 and the second seat part 40 of the saddle chair 10 is attached to the second support plate 80. Adjustment of the first angle α1 will thus adjust the gap G1 between the two seat parts 30, 40 of the saddle chair 10. Increasing the first angle α1 increases the gap G1 between the two seat parts 30, 40 of the saddle chair 10 at the front edge 11 of the saddle chair 10 and decreases the gap G1 between the two seat parts 30, 40 of the saddle chair 10 at the back edge 12 of the saddle chair 10 and vice a versa.

The adjustment device 100 may be supported on the bottom plate 60. The adjustment device 100 may be supported on the second upwards directed end portion 62 of the bottom plate 60. The adjustment device 100 may be a mechanical adjustment device. The adjustment device 100 may comprise a first shaft 105, a rotatable grip 110, a rotatable member 120, a first power transmission 130 and a second power transmission 140.

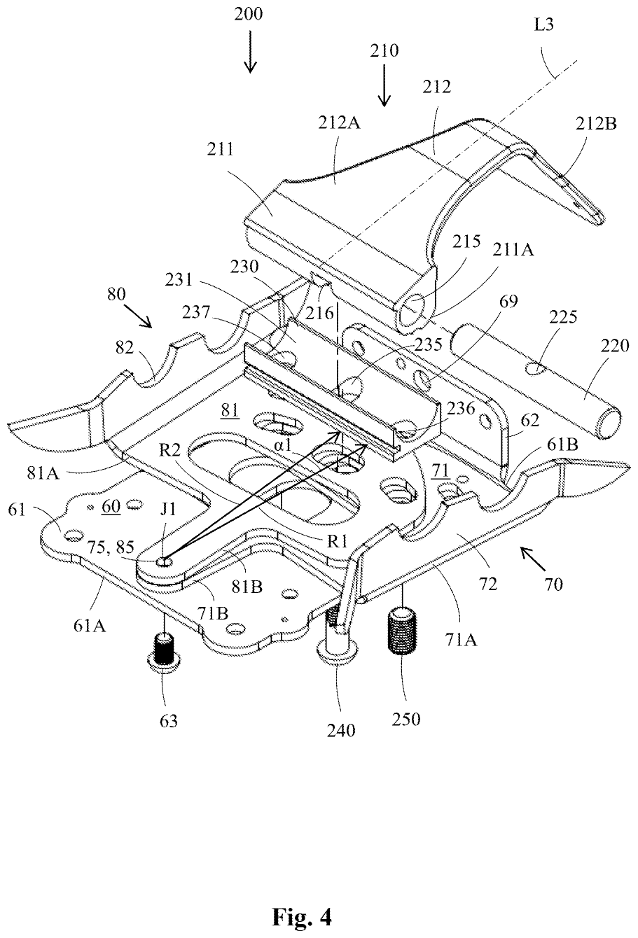

The first shaft 105 may be supported on the bottom plate 60. The first shaft 105 may be supported on the bottom plate 60 in a support point above the bottom plane. The first shaft 105 may be supported on the second end portion 62 of the bottom plate 60. The first shaft 105 may be supported in a hole 69 (shown in FIG. 4) passing through the second end portion 62 of the bottom plate 60. The first shaft 105 may pass through the hole 69 in the second end portion 62 of the bottom plate 60. The hole 69 may be a threaded hole so that a support cylinder with an outer threading may be inserted into the threaded hole 69. The first shaft 105 may then pass through the support cylinder. The first shaft 105 may thus be rotatable within the support cylinder. The first shaft 105 may be cylindrical. The support of the first shaft 105 on the bottom plate 60 should allow rotation of the first shaft 105.

The grip 110 may be attached to a first end of the first shaft 105 outside the second end portion 62 of the bottom plate 60. The rotatable member 120 may be attached to a second opposite end of the first shaft 105 inside the second end portion 62 of the bottom plate 60. The rotatable member 120 may be formed as a rotatable plate having a round or irregular form or as a rotatable arm having two opposite ends. Rotation of the grip 110 rotates the first shaft 105 and thereby also the rotatable member 120. The grip 110 may be formed as a knob or as a handle or as a shaft.

The first power transmission 130 may extend between the rotatable member 120 and the first support plate 70. The first power transmission 130 may be formed as a first arm 130. Both ends of the first arm 130 may comprise pivots. The pivots may be formed as ball joints. A first end of the first arm 130 may be connected to rotatable member 120 and a second opposite end of the first arm 130 may be connected to the first support plate 70.

The second power transmission 140 may extend between the rotatable member 120 and the second support plate 80. The second power transmission 140 may be formed as a second arm 140. Both ends of the second arm 140 may comprise pivots. The pivots may be formed as ball joints. A first end of the second arm 140 may be connected to the rotatable member 120 and a second opposite end of the second arm 140 may be connected to the second support plate 80. The first end of the first arm 130 and the first end of the second arm 140 are connected to the rotatable member 120 at opposite sides of the first shaft 105. The first shaft 105 may be connected to a middle portion of the rotatable member 120. The first end of the first arm 130 and the first end of the second arm 140 may be connected to an outer part of the rotatable member 120 on opposite sides of the first shaft 105. In an embodiment in which the rotatable member 120 is formed as a rotatable arm 120, the first end of the first arm 130 and the first end of the second arm 140 may be connected to opposite ends of the rotatable arm 120.

The first arm 130 may transfer the rotational movement of the rotatable member 120 into a linear movement acting on the first support plate 70. The second arm 140 may transfer the rotational movement of the rotatable member 120 into a linear movement acting on the second support plate 80. The first arm 130 and the second arm 140 may be replaced with some other elements being able to transfer power between the rotatable member 120 and the respective support plates 70, 80. E.g. cog wheels could be used in the first power transmission 130 and in the second power transmission 140.

Rotation of the grip 110 in a first direction i.e. counter-clockwise in the figure pushes the first arm 130 and the second arm 140 in opposite directions away from each other so that the first angle α1 is increased. The first support plate 70 and the second support plate 80 will thus be turned in opposite directions away from each other around the first pivot J1.

Rotation of the grip 110 in a second opposite direction i.e. clockwise in the figure pulls the first arm 130 and the second arm 140 in opposite directions towards each other so that the first angle α1 is decreased. The first support plate 70 and the second support plate 80 will thus be turned in opposite directions towards each other around the first pivot J1.

The first arm 130 and the second arm 140 also keep the first support plate 70 and the second support plate 80 on the bottom plate 60. It is thus not possible to lift the first support plate 70 and the second support plate 80 upwards away from the bottom plate 60.

The vertical plane of symmetry P10 may pass through a middle point of the first pivot J1 and through a centre axis of the first shaft 105. The bridge support device 50 may thus also be symmetrical in view of the vertical symmetry plane P10.

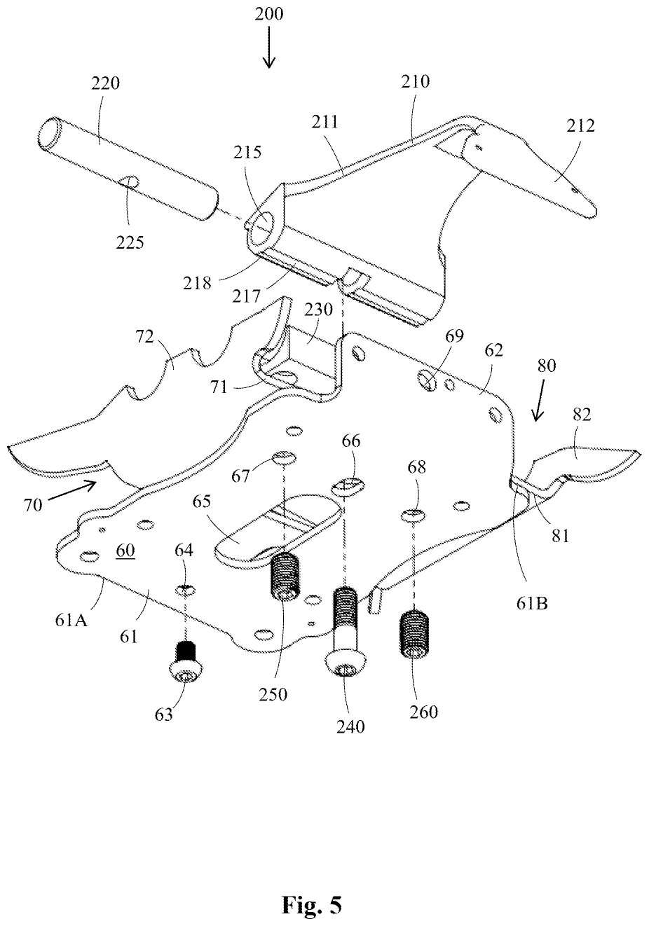

FIG. 4 shows a top view of a locking device in the bridge support device of the saddle chair and FIG. 5 shows a bottom view of the locking device of FIG. 4.

The bottom plate 60 may comprise a first plate portion 61 and a second end portion 62. The first plate portion 61 may have a first edge 61A and a second edge 61B. The second end portion 62 may extend along the second edge 61B of the first plate portion 61.

The first support plate 70 may comprise a first plate portion 71 and a second side portion 72. The first plate portion 71 may extend in the first plane. The second side portion 72 may extend upwards from a side edge of the first plate portion 71. The second side portion 72 may be inclined in relation to the first plate portion 71. The angle between the first plate portion 71 and the second side portion 72 may be substantially 90 degrees. The first plate portion 71 may comprise a plate 71A and an arm 71B extending outwards from a middle portion of the plate 71A. The first pivot J1 may be provided on an outer end of the arm 71B in the form of a hole for a screw. The plate 71A and the arm 71B may both extend in the first plane. The second side portion 72 may be arranged in a side edge of the plate 71A. The first support plate 70 may be formed of a single plate whereby the second side portion 72 is formed by bending the plate so that a side portion i.e. the second side portion 72 of the plate extends upwards form the first plane. The first plate portion 71 and the second end portion 72 may on the other hand be formed of two different parts being attached to each other by welding or by a pressure joint e.g. based on screws or bolts and nuts. An upper edge of the second side portion 72 of the first support plate 70 may be welded to the first seat plate 35 in the first seat part 30.

The second support plate 80 may comprise a first plate portion 81 and a second end portion 82. The first plate portion 81 may extend in the second plane. The second side portion 82 may extend upwards from a side edge of the first plate portion 81 of the first plate portion 81. The second side portion 82 may be inclined in relation to the first plate portion 81. The angle between the first plate portion 81 and the second side portion 82 may be substantially 90 degrees. The first plate portion 81 may comprise a plate 81A and an arm 81B extending outwards from a middle portion of the plate 81A. The first pivot J1 may be provided on an outer end of the arm 81B in the form of a hole for a screw. The plate 81A and the arm 81B may both extend in the second plane. The second side portion 82 may be arranged in a side edge of the plate 81A. The second support plate 80 may be formed of a single plate whereby the second side portion 82 of the plate extends upwards from the second plane. The first plate portion 81 and the second end portion 82 may on the other hand be formed of two different parts being attached to each other by welding or by a pressure joint e.g. based on screws or bolts and nuts. An upper edge of the second side portion 82 of the second support plate 80 may be welded to the second seat plate 45 in the second seat part 40.

The side edge of the second support plate 80 opposite to the second inclined side portion 82 of the second support plate 80 seats against the second inclined side portion 72 of the first support plate 70 when the first support plate 70 and the second support plate 80 are in a neutral position i.e. the angle α1 is zero. The side edge of the first support plate 70 and of the second support plate 80 that is opposite to the arm 71B, 81B may be curved.

The bridge support device 50 may further comprise a locking device 200 for locking and unlocking the first support plate 70 and the second support plate 80 in relation to each other and in relation to the bottom plate 60. Adjustment of the first angle α1 i.e. adjustment of the width of the gap G1 between the two seat parts 30, 40 in the seat 20 of the saddle chair 10 is possible when the locking device 200 is in an unlocked position and prohibited when the locking device 200 is in a locked position.

The locking device 200 may be supported on the bottom plate 60. The locking device 200 may be a mechanical locking device. The locking device 200 may comprise a handle 210, a second shaft 220, a lock profile 230, a screw 240, and two plungers 250, 260.

The handle 210 may comprise a base portion 211 and a grip portion 212.

The base portion 211 may comprise a hole 215 extending through the base portion 211 in a direction being perpendicular to a longitudinal direction L3 of the handle 210. The through hole 215 may receive the second shaft 220. The base portion 211 may further comprise a first recess 216. The first recess 216 may be positioned in a middle portion of the base portion 211 measured in a longitudinal direction of the second shaft 220. The first recess 216 may extend from and outer surface of the base portion 211 to the hole 215 inside the base portion 211. The first recess 216 may provide access for the screw 240 extending from the bottom surface of the bottom plate 60 to the second shaft 220 positioned in the hole 215 of the base portion 211 of the shaft 220. The first recess 216 makes it also possible for the base portion 211 of the handle 210 to be rotated around the second shaft 220 between an open position and a locked position. The base portion 211 may further comprise an eccentric bottom surface 211A. The eccentric surface 211A may be positioned under the hole 215 for the second shaft 220. The base portion 211 may further comprise a first groove 217 and a second groove 218 extending in the longitudinal direction of the hole 215 in the base portion 211.

The grip portion 212 may be formed of a longitudinal flat grip extending outwards from the base portion 211. The grip portion 212 may be formed of an inner part 212A extending in the longitudinal direction L3 of the handle 210 outwards from the base part 211 and an outer part 212B. The outer part 212B may be inclined in relation to the inner part 212A.

The second shaft 220 may be cylindrical. The second shaft 220 may extend in a direction being perpendicular in relation to the longitudinal direction L3 of the handle 210. The second shaft 220 may comprise a threaded hole 225 extending in a direction being perpendicular in relation to a longitudinal centre axis of the shaft 220. The threaded hole 225 may extend through a middle portion of the shaft 220 in relation to the longitudinal centre axis of the shaft 220. The screw 240 may extend through the bottom plate 60, through the first support plate 70, through the second support plate 80, through the lock profile 230, and through the groove 216 to the threaded hole 225 in the second shaft 220. The second shaft 220 becomes thus stationary attached to the bottom plate 60. The handle 210 becomes thus rotatable attached to the bottom plate 60. The handle 210 is rotatable in relation to the stationary second shaft 220.

The lock profile 230 may comprise a plain bottom surface and a curved support surface 231. The bottom surface of the lock profile 230 may be seated against the upper surface of the second support plate 80 in the support arrangement 50. The bottom surface of the lock profile 230 may be coarse or coated with a coarse coating so that the friction of the bottom surface of the lock profile 230 is at a desired level. The lock profile 230 may be provided with a first opening 235 for the screw 240, with a second opening 236 for the first plunger 250 and with a third opening 237 for the second plunger 260. The bottom plate 60, the first support plate 70, and the second support plate 80 are also provided with corresponding openings for the screw 240 and the two plungers 250, 260. The eccentric bottom surface 211A of the base portion 211 of the handle 210 may be seated in the curved support surface 231 of the lock profile 230.

The bottom plate 60 may comprise a threaded opening 64 for the screw 63 forming the first pivot J1. The bottom plate 60 may further comprise a plain hole 66 for the screw 240 attaching the handle 210 to the bottom plate 60. The bottom plate 60 may further comprise a hole 67, 68 for each of the plungers 250, 260. The holes 67, 68 for the plungers 250, 260 may be formed of a threaded hole 67, 68 mating with an outer threading of the plungers 250, 260. The plungers 250, 260 may thus be screwed into the threaded holes 67, 68 in the bottom plate 60 so that the plungers 250, 260 become supported by the bottom plate 60. The plungers 250, 260 may be provided with an outer threading and with a spring loaded ball at an outer end of the plungers 250, 260. The spring loaded ball may be pressed inwards into the plunger 250, 260 against the force of a spring positioned within the plunger 250, 260. The bottom plate 60 may further comprise a hole 69 in the second end portion 62 of the bottom plate 60 for the first shaft 105 of the adjustment device 100. The bottom plate may further comprise an oblong opening 65 for the gas cylinder of the saddle chair 10.

The opening in the first support plate 70 and in the second support plate 80 for the screw 240 attaching the handle 210 to the bottom plate 60 and the openings in the first support plate 70 and in the second support plate 80 for the plungers 250, 260 may have a form and a size that enables the first support plate 70 and the second support plate 80 to move in relation to each other and in relation to the bottom plate 60 along a circumference of a circle having the centre point in the first pivot J1 when the distance of the gap G1 between the two seat parts 30, 40 in the saddle chair 10 is adjusted. The opening 75 in the first support plate 70 and the opening 85 in the second support plate 80 in the first pivot point J1 may be formed of holes having a diameter that is substantially equal to the outer diameter of the screw 63 forming the first pivot point J1.

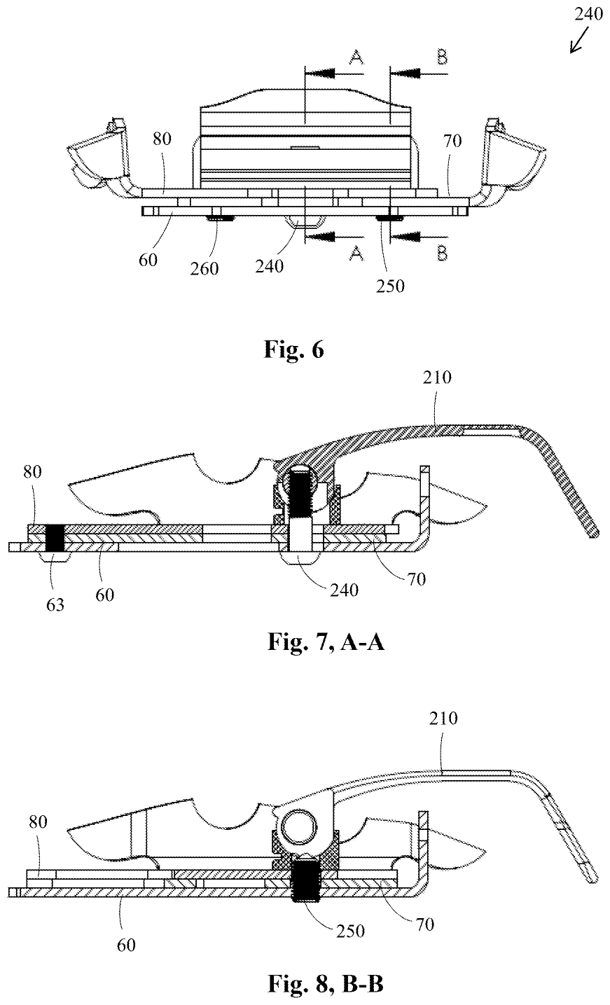

FIG. 6 shows a front view of the locking device of the saddle chair.

The figure shows the bottom plate 60, the first support plate 70, the second support plate 80, the screw 240 attaching the handle 210 to the bottom plate 60, and the plungers 250, 260.

FIG. 7 shows a cross section A-A of FIG. 6.

The figure shows the bottom plate 60, the first support plate 70, the second support plate 80, the handle 210, the screw 240 attaching the handle 210 to the bottom plate 60, and the screw 63 forming the first pivot J1 for the first support plate 70 and the second support plate 80.

FIG. 8 shows a cross section B-B of FIG. 6.

The figure shows the bottom plate 60, the first support plate 70, the second support plate 80, the handle 210, and the first plunger 250 for locking the handle 210 in the locking and in the open position.

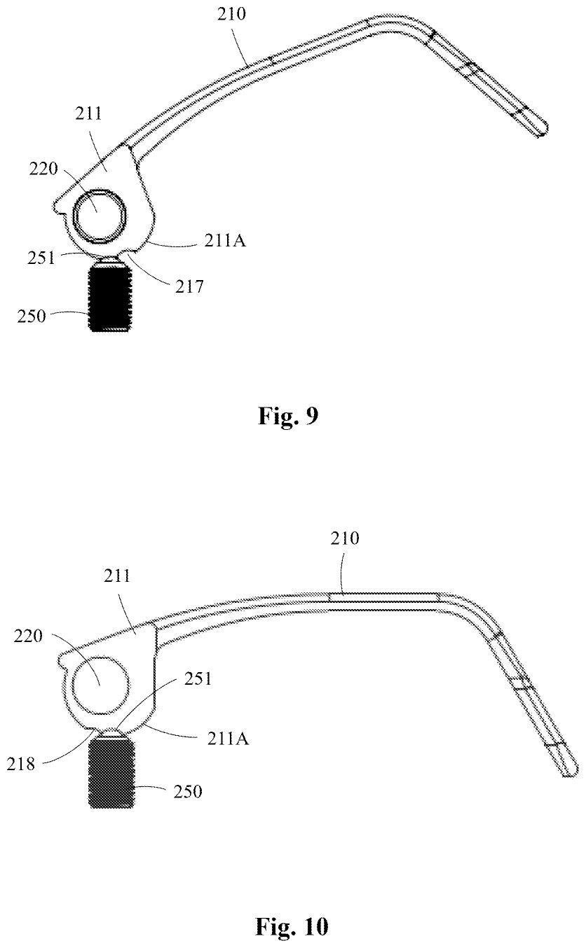

FIG. 9 shows a side view of the handle of the locking device in an open position and FIG. 10 shows a side view of the handle of the locking device in an open position.

The figures show the handle 210, the second shaft 220 in the handle 210, and the first plunger 250. The handle 210 rotates around the stationary second shaft 220. The base portion 211 of handle 210 is provided with a first groove 217 and a second groove 218 adapted to receive the spring loaded ball 251 of the plungers 250, 260. The grooves 217, 218 run in a direction parallel to the longitudinal direction of the hole 215 in the base part 211 of the handle 210 receiving the second shaft 220. The grooves 217, 218 may extend across the whole width of the base portion 211 of the handle. The width of the base portion 211 is measured in an axial direction of the hole 215 receiving the second shaft 220. The spring loaded balls 251 of the plungers 250, 260 are pressed into the first groove 217 when the handle 210 is in the locked position and into the second groove 218 when the handle 210 is in the unlocked position. The grooves 217, 218 are positioned in the eccentric bottom surface 211A of the base portion 211 of the handle 210. The eccentric bottom surface 211A of the base portion 211 of the handle 210 seats against the curved support surface 231 of the lock profile 230. This eccentric bottom surface 211A will thus press the lock profile 230 downwards against the second support plate 80 when the handle 210 is in the locked position shown in FIG. 10. The pressure exerted by the lock profile 230 on the second support plate 80 will lock the first support plate 70 and the second support plate 80 in relation to the bottom plate 60. The friction between the bottom plate 60 and the first support plate 70 and the friction between the first support plate 70 and the second support plate 80 keeps the first support plate 70 and the second support plate 80 stationary in relation to the bottom plate 60. The bottom plate 60, the first support plate 70 and the second support plate 80 may be coated with a coating in order to adjust the friction between said parts 60, 70, 80 to a desired level.

The spring will press the spring loaded ball 251 into the respective groove 217, 218 with a certain spring force so that a greater force is needed in order to rotate the handle 210 from the position in which the spring loaded balls 251 are in the respective grooves 217, 218. The user will get a haptic feedback from the handle when the spring loaded balls 251 in the plungers 250, 260 protrude into either groove 217, 218. The haptic feedback from the handle 210 indicates that the correct position i.e. locked or unlocked of the handle 210 has been reached.

The figure shows two plungers 250, 260, which is an advantageous solution. Any number of plungers one, two, three, four etc. could, however, be used.

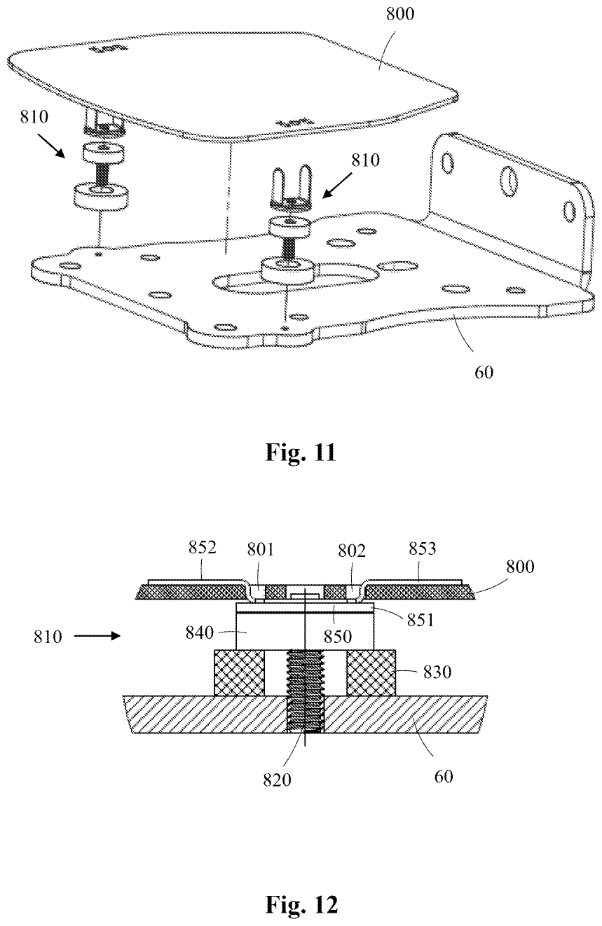

FIG. 11 shows a dust cover to be used in the saddle chair and FIG. 12 shows a cross section of the support element of the dust cover.

The dust cover 800 may be supported on the bottom plate 60 with two support elements 810. Each of the support elements 810 may comprise a threaded rod 820, a spacer 830, a first magnetic snap 840, and a second snap 850.

The threaded rod 820 may be screwed into a threaded hole in the bottom plate 60. The threaded rod 820 extends through the spacer 830 and into a threaded hole in the first magnetic snap 840. The spacer 830 and the first magnetic snap 840 become thus attached to the bottom plate 60 via the threaded rod 820.

The second snap 850 may comprise a snap portion 851 and two brackets 852, 853. The second snap 850 may be attached to the dust cover 800 by pushing the upwards directed brackets 852, 853 through openings 801, 802 in the dust cover 800. The brackets 852, 853 are then bent against the upper surface of the dust cover 800. The second snap 850 become thus attached to the dust cover 800.

The spacer 830, the first magnetic snap 840 and the snap portion 851 may be cylindrical. The outer diameter of the first magnetic snap 840 may correspond to the outer diameter of the snap portion 851. The first magnetic snap 840 may be formed of a permanent magnet. The second snap 850 may be of a ferromagnetic material.

The dust cover 800 may thus be pushed on the first magnetic snaps 840 attached to the bottom plate 60 so that the second snaps 850 become substantially concentric with the first magnetic snaps 840. The second snaps 850 are attached to the first magnetic snaps 840 by the magnetic force of the permanent magnets. The dust cover 800 is positioned at a distance above the bottom plate 60 so that there remains enough space for the first support plate 70 and the second support plate 80 on the bottom plate 60.

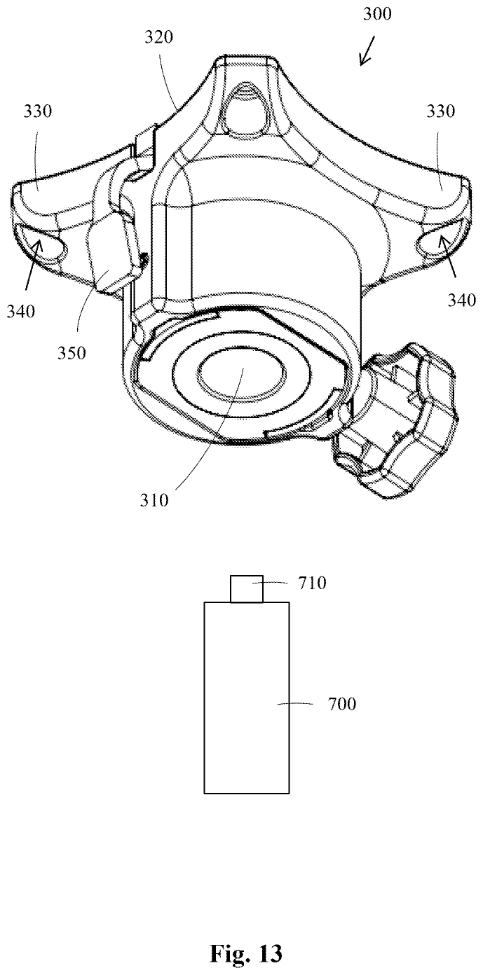

FIG. 13 shows a side view of a swing support device of a saddle chair.

The figure shows one embodiment of a swing support device 300 that may be connected between the support cylinder and the bridge support 50 in a saddle chair 10. The swing support device 300 may be attached with screws passing through plain holes 340 in the lugs 330 of the swing support device 300 to corresponding threaded holes in the bottom plate 60 in the bridge support device 50. The upper surface 320 of the swing support device 300 will be seated against the lower surface 60A of the bottom plate 60 in the bridge support device 50. The support cylinder 700 of the saddle chair will be inserted into the hole 310 in the middle of the swing support device 300. The swing support device 300 may at least comprise means e.g. a lever 350 for adjusting the height of the saddle chair 10. An inner end of the lever 350 may rest on the pin 710 of the gas cylinder 700. Pressing the pin 710 downwards into the gas cylinder 700 releases the gas cylinder 700 so that adjustment of the height of the chair 100 is possible. The swing support device 300 may in addition comprise means e.g. a knob 360 for adjusting of the stiffness of the swing of the seat 20 of the saddle chair 10.

The vertical symmetry plane P10 may pass along a centre axis of the support cylinder 700. The saddle chair 10 i.e. the seat parts 30, 40 and/or the bridge support device 50 may thus be symmetrical in view of the vertical symmetry plane P10 and in view of the centre axis of the support cylinder 700.

The swing support device 300 may be used in connection with a solid seat and a divided seat saddle chair. The swing support device 300 may in fact be used in connection with any kind of chair being supported by a support cylinder.

The bridge support device 50 and the swing support device 300 may together form a support arrangement between the support cylinder and the seat of the saddle chair. The swing support device 300 may be supported on the support cylinder 700 and the bridge support device 50 may be supported on the swing support device 300. The two seat parts 30, 40 in the divided seat 20 of the saddle chair 10 may be supported on the respective support plates 70, 80 in the bridge support device 50.

The bridge support device 50 may on the other hand form a support arrangement directly between the support cylinder 700 and the seat 20 of a saddle chair 10. A support part having a cylindrical portion with a muff being adapted to fit on the upper end of the support cylinder 700 would then be needed in the bridge support device 50. Said support part could be an integral part of the bridge support device 50 or a separate part attached to the bride support device 200.

The bridge support device 50 may connect the seat 20 of the saddle chair 10 to the support cylinder 700 of the saddle chair 100 directly or indirectly.

The use of a first pivot J1 as shown in the figures is an advantageous solution. The movement of the first support plate 70 and the second support plate 80 is fully controlled. The support plates 70, 80 may only rotate around the first pivot J1.

It will be obvious to a person skilled in the art that, as the technology advances, the inventive concept can be implemented in various ways. The invention and its embodiments are not limited to the examples described above but may vary within the scope of the claims.

The invention claimed is:

1-14 (canceled)

15. A saddle chair (10) with a divided seat (20) for reducing pressure on the perineum and lowering temperature in the genital area, the divided seat (20) comprising a first seat part (30) and a second seat part (40), wherein:
the first seat part (30) and the second seat part (40) are arranged pivotably such that they are rotatable around a pivot (J1) positioned near a back edge (12) of the divided seat (20), leaving an adjustable gap (G1) at a front edge (11) of the divided seat (20); and
the saddle chair (10) further comprises a locking device (200) for locking and unlocking a pivotal position of the first seat part (30) and of the second seat part (40).

16. The saddle chair (10) according to claim 15, wherein:
the saddle chair (10) further comprises a bridge support device (50), the first seat part (30) being supported on a first support plate (70) of the bridge support device (50) and the second seat part (40) being supported on a second support plate (80) of the bridge support device (50);
the first seat part (30) and the second seat part (40) are positioned on a stationary bottom plate (60) of the bridge support device (50), the pivot (J1) being on the bottom plate (60);
the first support plate (70) and the second support plate (80) are movably supported via the first pivot (J1) on the stationary bottom plate (60) so that the first support plate (70) and the second support plate (80) are movable in relation to each other and in relation to the bottom plate around the first pivot (J1).

17. The saddle chair (10) according to claim 15, wherein the saddle chair (10) further comprises a grip (110), such as a handwheel, connected via a shaft (105) to a rotatable member (120), such as a rotatable plate, arranged by its rotating movement to move a first arm (130) to pivot the first seat part (30) in a first direction and a second arm (140) to simultaneously pivot the second seat part (40) in to a second direction that is opposite to the first direction.

18. The saddle chair (10) according to claim 15, wherein the saddle chair (10) further comprises a grip (110), such as a handwheel, connected via a shaft (105) to a rotatable member (120), such as a rotatable plate, arranged by its rotating movement to operate power transmissions such as cog wheels to pivot the first seat part (30) in a first direction and the second seat part (40) in a second direction that is opposite to the first direction.

19. The saddle chair (10) according to claim 15, wherein the pivoting of the first seat part (30) and of the second seat part (40) is guided by form-locking means.

20. The saddle chair (10) according to claim 15, wherein the pivoting of the first seat part (30) and of the second seat part (40) is carried out symmetrically such that an adjustable gap (G1) is widened or narrowed by respective pivoting of the first seat part (30) and of the second seat part (40).

21. The saddle chair (10) according to claim 15, wherein the saddle chair (10) further comprises a support cylinder (700) arranged such that the pivoting of the first seat part (30) and of the second seat part (40) is carried out symmetrically with respect to the support cylinder.

22. The saddle chair (10) according to claim 21, wherein: a longitudinal centre line (L10) of the saddle chair (10) passes along the gap (G1) between the first seat part (30) and the second seat part (40).

23. The saddle chair (10) according to claim 21, wherein the first seat part (30) and the second seat part (40) are symmetrical in view of a vertical symmetry plane (P10) that passes along a centre axis of the support cylinder (700) and also in view of the centre axis of the support cylinder (700).

24. The saddle chair (10) according to claim 15, wherein the locking device (200) comprises an eccentric surface (211A) that is rotatable by a handle (210), the eccentric surface (211) configured in the locked position to press a lock profile (230) against a support plate (80), the friction caused by pressure locking support plates (70, 80) in relation to a bottom plate (60) to prevent pivoting of the first seat part (30) and of the second seat part (40).

25. The saddle chair (10) according to claim 24, wherein:
the eccentric surface (211A) has a number of grooves (217, 218) and wherein the locking device (200) further comprises a number of spring loaded balls (251) of plungers (250, 260) such that the spring loaded balls (251) are pressed into a first groove (217) when the handle is in the locked position and into a second groove (218) when the handle (211) is in the unlocked position.

26. The saddle chair (10) according to claim 15, wherein:
the saddle chair (10) further comprises a swing support device (300) between a support cylinder (700) and a bridge support (50) supporting the first seat part (30) and the second seat part (40), for providing swing of the saddle chair (10).

27. The saddle chair (10) according to claim 15, wherein the first seat part (30) and the second seat part (40) jointly have a seat surface having a design of an equestrian saddle but with an adjustable gap (G1) at the front edge (11) between the first seat part (30) and the second seat part (40) for reducing pressure on the perineum and lowering temperature in the genital area.
